(19) United States
(12) Patent Application Publication
(10) Pub. No.: US 2017/0343716 A1
(43) Pub. Date: Nov. 30, 2017

(54) System and Method for Polarization Compensation

(71) Applicant: Digital Signal Corporation, Chantilly, VA (US)

(72) Inventors: Xiaoke Wan, Fairfax, VA (US); Hani Daniel, Rockville, MD (US); Chris Roller, Fairfax, VA (US)

(73) Assignee: Digital Signal Corporation, Chantilly, VA (US)

(21) Appl. No.: 15/405,430

(22) Filed: Jan. 13, 2017

Related U.S. Application Data
(60) Provisional application No. 62/279,093, filed on Jan. 15, 2016.

(51) Int. Cl. G02B 5/30; G02B 27/28; G01S 7/499

(52) U.S. Cl. CPC G02B 5/3083; G01S 7/499; G02B 27/283

(57) ABSTRACT

Various implementations of the invention, improve an optical efficiency of an optical path comprising a polarizing beam splitter and a quarter wave plate. In some implementations of the invention, where an additional optical component introduces a phase retardance into the optical path, the quarter wave plate may be adjusted away from its nominal orientation relative to the optical path to improve an optical efficiency of the optical path.

### CROSS-REFERENCE TO RELATED APPLICATIONS

This Application claims priority to U.S. Provisional Application No. 62/279,093, which was filed on Jan. 15, 2016, and entitled “System and Method for Polarization Compensation.” The foregoing application is incorporated herein by reference in its entirety.

### FIELD OF THE INVENTION

The invention is generally related to circular polarization in an optical transmitter/receiver system (e.g., laser radar system or lidar), and more particularly, to compensating for optical components that introduce phase retardance in a circularly polarized optical path of the transmitter/receiver system.

### BACKGROUND OF THE INVENTION

Various conventional transmitter/receiver systems, including, but not limited to laser radar systems, employ circular polarization to improve, optimize, and/or maximize an optical efficiency of such systems. FIG. 1 illustrates a conventional configuration of a transmitter/receiver system 100 incorporating a circular polarizer 120 that includes a polarization beamsplitter (“PBS”) 130 and a quarter wave plate (“QWP”) 140 at 45° relative to a polarization axis defined by PBS 130. As would be appreciated, in such a configuration the optical efficiency of transmitter/receiver system 100 is maximized, while the feedback to a light source 110 is minimized. If a return signal is from a single reflecting target 102, the optical efficiency of circular polarizer 120 may approach 100%. Employing circular polarizer 120 is much more advantageous than employing a non-polarization beamsplitter, which may only offer a maximum efficiency of 25%. Circular polarizer 120 may also offer an advantage of polarization regulation. Experimental results demonstrate that many common scattering targets, including biological tissues, partially preserve polarization, so circular polarizer 120 remains optimal even though the optimal efficiency is less than 100%.

As would be appreciated, other optical components may be incorporated into the basic configuration of transmitter/receiver system 100, such as a focusing lens (not otherwise illustrated), a steering mirror 220, and/or a viewport system 230 with a beamsplitter 235, as illustrated, for example, in FIG. 2. Some of these optical components have an impact on optimal optical efficiency. In general, optical components such as lenses have little impact on polarization because angles of incidence (AOIs) of light onto these components normally approach zero. However, as AOIs become larger, such as those associated with steering mirror 220 and beamsplitter 235, optical efficiency may be impacted. By way of example, a phase retardance of a typical steering mirror with protected gold coating (such as steering mirror 220) may vary within a range of +/−30 degrees at a 45° of AOI; and a typical wavelength-selective dichroic beamsplitter (such as beamsplitter 235) may have a similar magnitude of phase retardance.

FIG. 3 illustrates that the optical efficiency of a system may be significantly affected by adding a component to the system having a retardance of greater than 10°. For systems having two or more such components, the accumulative retardance can easily exceed 45°, and the optical efficiency of such a system may become so poor that removing QWP 140 from the system might actually improve the optical efficiency.

What is needed is a transmitter/receiver system that compensates for retardance introduced by various optical components included in transmitter/receiver systems.

### SUMMARY OF THE INVENTION

Various implementations of the invention, improve an optical efficiency of an optical path comprising a polarizing beam splitter and a quarter wave plate. In some implementations of the invention, where an additional optical component introduces a phase retardance into the optical path, the quarter wave plate may be adjusted away from its nominal orientation relative to the optical path to improve an optical efficiency of the optical path. In some implementations of the invention, the quarter wave plate may be rotated off of a nominal 45° angle relative to a polarization axis of the polarization beam splitter. In some implementations of the invention, quarter wave plate may be tilted off of a nominal 0° angle of incidence relative to the optical path. In some implementations of the invention, the quarter wave plate may be rotated off of a nominal 45° angle relative to a polarization axis of the polarization beam splitter and tilted off of a nominal 0° angle of incidence relative to the optical path.

These implementations, their features and other aspects of the invention are described in further detail below.

### BRIEF DESCRIPTION OF THE DRAWINGS

FIG. 1 illustrates a prior art transmitter/receiver system incorporating a circular polarizer including a polarization beamsplitter and a quarter wave plate at 45°.

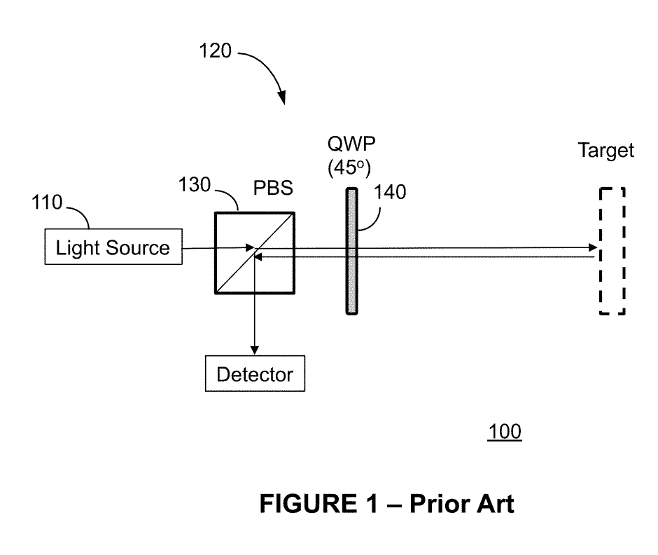

FIG. 2 illustrates a prior art transmitter/receiver system including additional optical components such as a focusing lens, a steering mirror, and/or a viewport system.

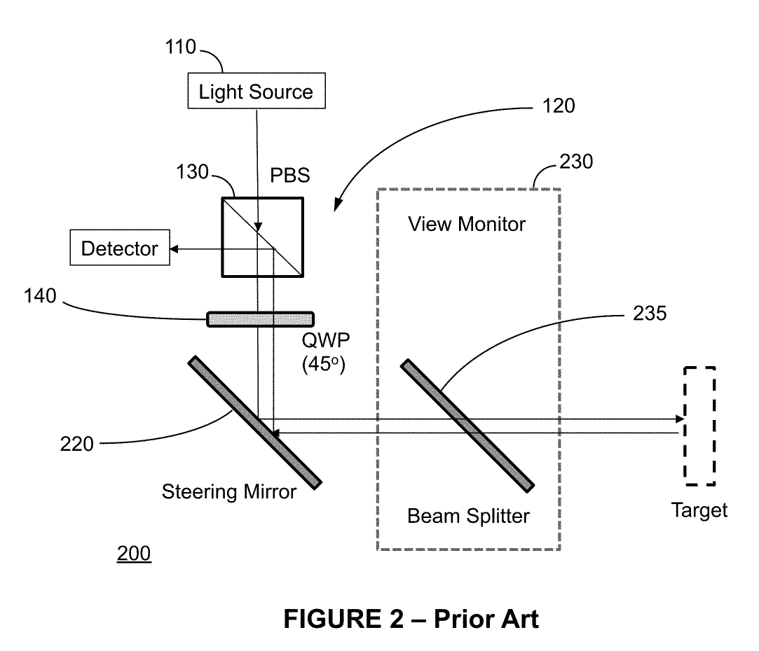

FIG. 3 illustrates that an optical efficiency of a system may be significantly affected by adding a component having a retardance of greater than 10 degrees to the system.

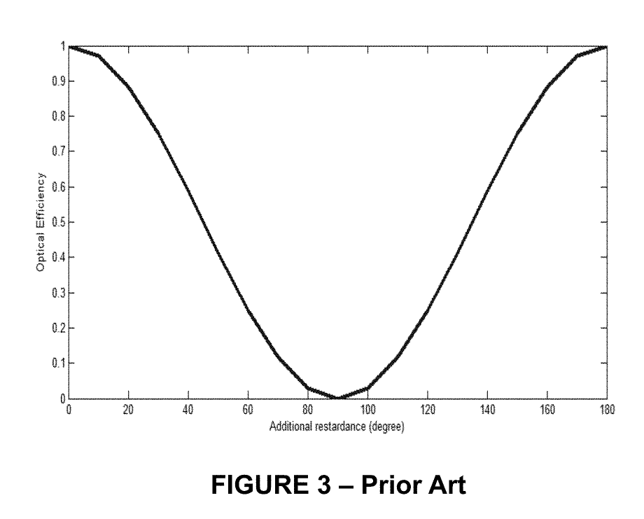

FIG. 4 illustrates a transmitter/receiver employing a circular polarizer according to various implementations of the invention.

FIG. 5 illustrates a transmitter/receiver employing a circular polarizer according to various implementations of the invention.

FIG. 6 illustrates various curves of optical efficiency as a function of an angle of rotation between a quarter wave plate and a polarizing beam splitter for each of various retardances introduced by optical components in the optical path in accordance with various implementations of the invention.

FIG. 7 illustrates a configuration useful for adjusting a quarter wave plate relative to the optical path in accordance with various implementations of the invention.

### DETAILED DESCRIPTION

Chirped lidar systems employ two or more laser sources to provide chirped lidar signals. These chirped lidar signals, when incident upon and reflected back from a point on a target, may be detected and used to determine a range and an instantaneous Doppler velocity of the point on the target. Such a lidar system is available from Digital Signal Corporation of Chantilly, Va., and is described in its U.S. Pat. No. 7,511,824, entitled “Chirped Coherent Laser Radar System and Method,” which issued on Mar. 31, 2009. The foregoing patent is incorporated herein by reference as if reproduced below in its entirety.

The lidar system referenced above (which may be considered a transmitter/receiver for purposes of this description) employs linear polarization for the optical path comprising a majority of the optical components and fibers (i.e., fiber optics) and circular polarization for the optical path of free space from the lidar system to a target and back (i.e. free-space path). As would be appreciated, circularly polarized light is not impacted by being reflected off of the target to the same degree as linearly polarized light. According to various implementations of the invention, the linearly polarized light of the fiber optics is converted to circular polarization by quarter wave plate 140 after it leaves a fiber tip of the lidar system. Quarter wave plate 140 is oriented such that its optical axis is nominally 45° to an axis of linear polarization of the light coming from the fiber tip. Other elements in the free-space path, such as steering mirror 220, window 230 and/or beam splitter 235 (which alone or in the aggregate introduce more than 10 degrees of retardance into the lidar system) affect the circularity/ellipticity of this circularly polarized light, thereby ultimately reducing a sensitivity of the lidar system. Accordingly, various implementations of the invention compensate for the retardance introduced by such optical components into transmitter/receiver configurations such as the lidar system of U.S. Pat. No. 7,511,824.

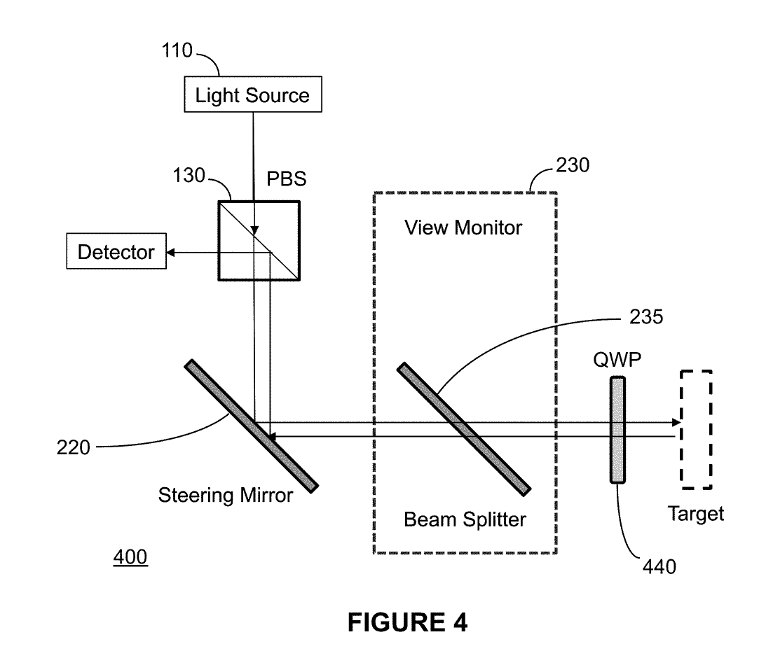

FIG. 4 illustrates a transmitter/receiver configuration 400 according to various implementations of the invention that compensates for retardance introduced by added optical components by arranging such components such that they reside in the optical path between polarization beam splitter 130 and quarter wave plate 440. For example, configuration 400 includes added components, namely, a steering mirror 220 and a beam splitter 235, disposed in an optical path between polarization beam splitter 130 and quarter wave plate 440. As would be appreciated, the optical path may incorporate free space, optical fiber, or other optical paths or combinations thereof, between polarization beam splitter 120 and quarter wave plate 440. An optical efficiency of such a configuration 400 is not degraded when: 1) light incident on such added components is linearly polarized at such added components and 2) a direction of the polarization of the light is aligned parallel or orthogonal to the planes of incidence. When both these conditions are met, the added components introduce little to no additional phase retardance within configuration 400.

In general, various implementations of the invention may utilize individual optical components designed to have minimal phase retardance or may utilize a group of optical components configured to cancel out one another's phase retardance. However, coating manufacturers are typically reluctant to control or specify retardance parameters. Nonetheless, experiments demonstrate that phase retardance is consistent among optical components having coatings within the same coating batch or the same coating recipe. Accordingly, in these implementations of the invention, optical components may be specified to be from a same coating batch or at least to have a same coating recipe. Such implementations may avoid a higher coating cost of directly specifying the phase retardance parameter of the optical components.

Some implementations of the invention (not otherwise illustrated) may arrange a pair or multiple optical components such that their collective retardances fully or partially cancel one another. This may be accomplished by, for example, configuring a pair of steering mirrors, each having an identical coating (i.e., either from a same coating batch or a same coating recipe), to have an aggregate retardance of zero if the planes of incidence are orthogonally arranged. This pair of steering mirrors may be arranged next to each other in the optical path, or they may sandwich some other optical components in the optical path. Similarly, a second beam splitter 235 may be inserted in the optical path to cancel the retardance of a first, identical, beam splitter 235, by, for example, making the planes of incidence orthogonal. This pair of beamsplitters may be arranged next to each other in the optical path, or they may sandwich some other optical components in the optical path.

Various implementations of the invention fully or partially compensate for retardance introduced by additional optical components, such as, but not limited to, focusing lenses, steering mirror 220, beam splitter 235, etc., by adjusting a quarter wave plate (such as quarter wave plate 140). In some implementations of the invention, quarter wave plate 140 may be adjusted by rotating quarter wave plate 140 to an angle other than nominally 45° relative to the polarization axis defined by polarization beam splitter 130 to fully or partially compensate for retardance introduced by additional optical components. In some implementations of the invention, quarter wave plate 140 may be adjusted by tilting quarter wave plate 140 such that it is not nominally orthogonal to the optical path or otherwise away from a nominal angle of incidence to fully or partially compensate for retardance introduced by additional optical components. In some implementations of the invention, quarter wave plate 140 may be adjusted by changing to a phase retarder plate with tuned retardance off from 90° at the relevant wavelength to fully or partially compensate for retardance introduced by additional optical components. Other adjustments may be made to quarter wave plate 140 such that it compensates for the retardance introduced by additional optical components as will become apparent from this description.

For example, some implementations of the invention compensate for retardance introduced by additional optical components, such as, but not limited to, steering mirror 220, beam splitter 235, etc., by tuning the phase retardance of a quarter wave plate off from nominally 90° to fully or partially compensate for the retardance introduced by the additional optical components. This tuning may be accomplished by specifying a nominal retardance for the quarter wave plate of a value other than 90° at the applicable wavelength, specifying a retardance of 90° at a different wavelength, and/or tilting quarter wave plate slightly away from a nominal angle of incidence. This tuning mitigates retardance deviation over the entire optical path.

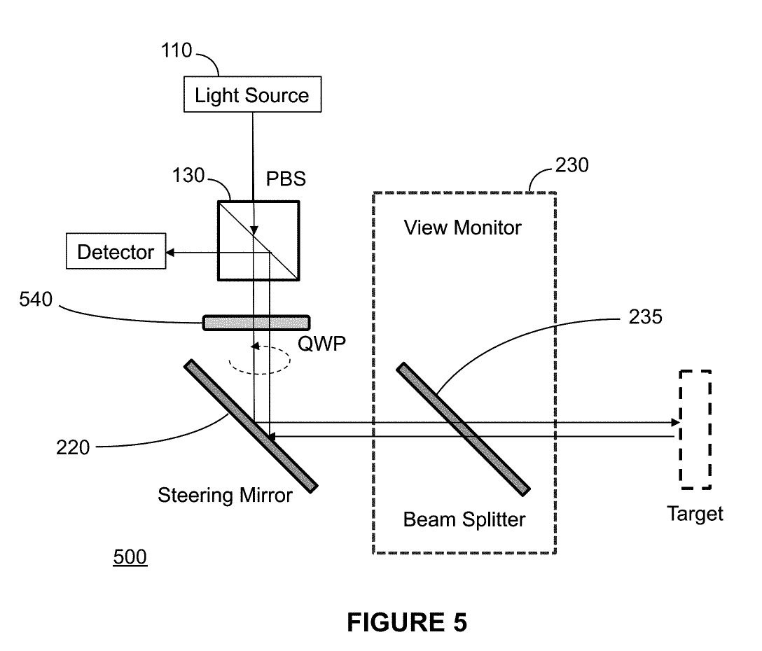

FIG. 5 illustrates a transmitter/receiver configuration 500 according to various implementations of the invention. In some implementations of the invention, configuration 500 compensates for retardance introduced by additional optical components, such as, but not limited to, steering mirror 220, beam splitter 235, etc., by adjusting quarter wave plate 540 off from a nominal position relative to polarization beam splitter 130 and the optical path. In some implementations of the invention, configuration 500 compensates for retardance introduced by additional optical components by rotating quarter wave plate 540 off from a nominal 45° angle relative to a polarization axis of polarization beam splitter 130. In some implementations of the invention, configuration 500 compensates for retardance introduced by the additional optical components by rotating polarization beam splitter 130 off from a nominal 45° angle relative to quarter wave plate 540; however, rotating quarter wave plate 540 may be easier to accomplish. In some implementations of the invention, configuration 500 compensates for retardance introduced by additional optical components by tilting quarter wave plate 540 off from a nominal 0° angle of incidence relative to the optical path. In some implementations of the invention, configuration 500 compensates for retardance introduced by additional optical components by rotating quarter wave plate 540 off from a nominal 45° relative to the polarization axis defined by polarization beam splitter 130 and by tilting quarter wave plate 540 off from a nominal 0° angle of incidence relative to the optical path.

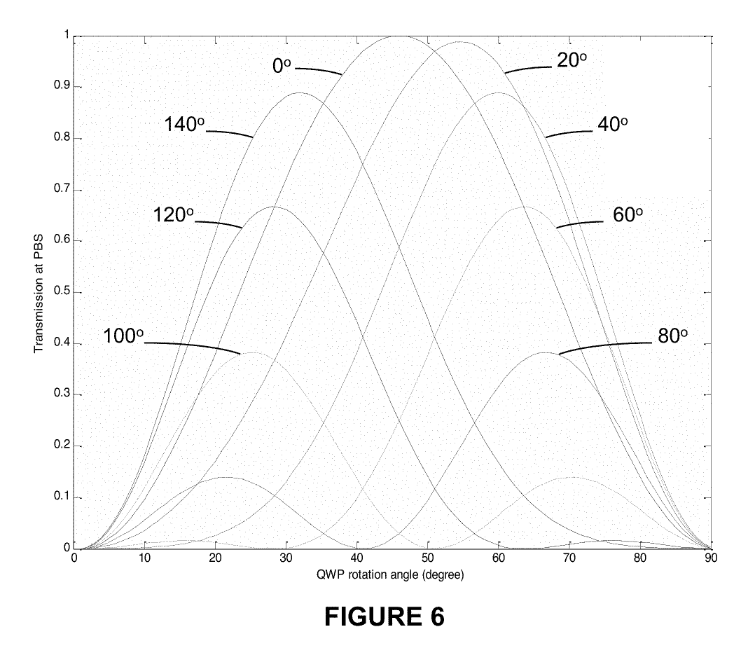

FIG. 6 illustrates various curves of optical efficiency as a function of an angle of rotation between quarter wave plate 540 and polarizing beam splitter 130 for each of various retardances introduced by additional optical components (illustrated in FIG. 6 as a curve for 0° added retardance, a curve for 20° added retardance, a curve for 40° added retardance, a curve for 60° added retardance, a curve for 80° added retardance, a curve for 100° added retardance, a curve for 120° added retardance, and a curve for 140° added retardance). As illustrated, each curve provides an optimal angle of rotation for quarter wave plate 540 that maximizes efficiency for configuration 540. Other than the curve for 0° of added retardance, none of the curves maximizes optical efficiency with quarter wave plate 540 nominally set at 45°. By way of example, when steering mirror 220 adds 40° of retardance to transmitter/receiver 500, an adjustment of quarter wave plate 540 to an angle of rotation of near 60° relative to the polarization axis defined by polarizing beam splitter 130 maximizes optical efficiency of transmitter/receiver 500 to 90%, whereas its efficiency at a nominal angle of 45° is only roughly 60%.

As would be appreciated, a reflector target may be used while determining an adjustment angle of quarter wave plate 540 (i.e., by either tilting, rotating, or both) relative to polarizing beam splitter 130 to measure a strength of a signal received at the detector and thereby improve, optimize or maximize the optical efficiency of the optical path.

Adjusting quarter wave plate 540 to improve, optimize or maximize the optical efficiency of the optical path may also be accomplished by monitoring a state of polarization (SOP) with a commercial polarization analyzer located at the target in FIG. 5. Applying Jones calculus, one may demonstrate that the optical efficiency of the optical path is a monotonically increasing function of a degree of polarization (DOE) at the target location. Therefore, one can readily determine an adjustment angle (i.e., rotating and/or tilt) of quarter wave plate 540 relative to the optical path that improves, optimizes or maximizes the optical efficiency of the optical path by monitoring the DOE at the target location.

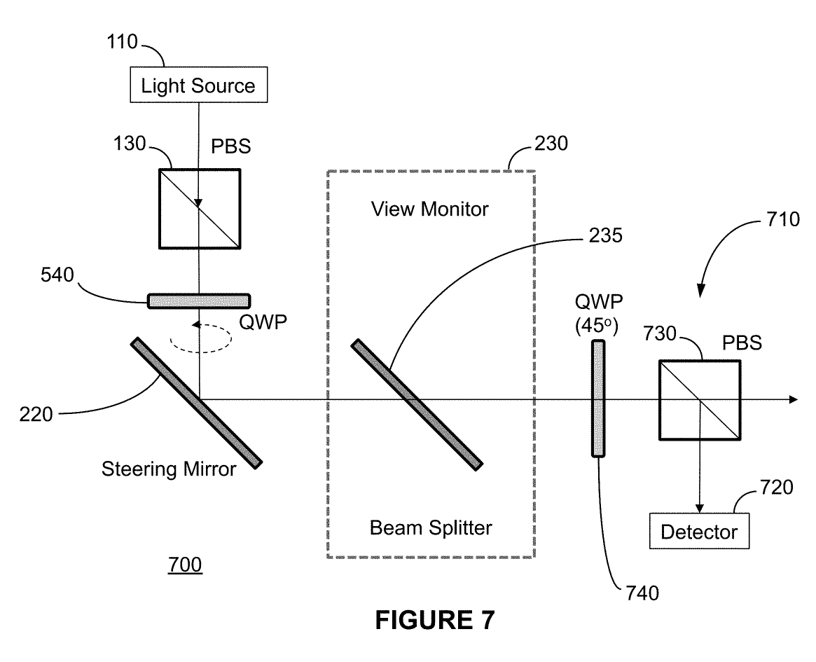

FIG. 7 illustrates another configuration 700 useful for adjusting quarter wave plate 540 relative to the optical path. As illustrated, configuration 700 includes a circular polarizer detector 710 having a detector 720, a quarter wave plate 730 and a polarizing beam splitter 740. In this configuration 700, quarter wave plate 540 may be adjusted relative to the optical path to improve, optimize and/or maximize the signal at detector 720 as would be appreciated. Applying Jones calculus, one may demonstrate that, while adjusting quarter wave plate 540, whenever an optical power detected by circular polarizer detector 710 reaches either a maximum or a minimum at either port of circular polarizer detector 710, a maximum DOE value will also be reached. Therefore, one can readily determine an adjustment angle (i.e., rotating and/or tilt) of quarter wave plate 540 relative to optical path that improves, optimizes or maximizes the optical efficiency of the optical path by monitoring an optical power reading of circular polarizer detector 710. The optical efficiency may also be calculated by the measured maximum to minimum extinction ratio as would be appreciated.

While the invention has been described herein in terms of various implementations, it is not so limited and is limited only by the scope of the following claims, as would be apparent to one skilled in the art. These and other implementations of the invention will become apparent upon consideration of the disclosure provided above and the accompanying figures. In addition, various components and features described with respect to one implementation of the invention may be used in other implementations as well.

What is claimed is:

1. An circularly-polarized optical path comprising:
an optical component that introduces a phase retardance into the optical path; and
a quarter wave plate disposed within the optical path and adjusted off of a nominal orientation with respect to the optical path to compensate for the phase retardance introduced by the optical component, wherein the nominal orientation comprises a 45° angle relative to a polarization axis of the optical path and a 0° angle of incidence.

2. An optical path comprising:
a polarizing beam splitter that defines a polarization axis of the optical path;
an optical component that introduces a phase retardance to the circularly polarized radiation in the optical path; and
a quarter wave plate disposed within the optical path and configured relative to the optical path to compensate for the phase retardance introduced by the optical component.

3. The optical path of claim 2, wherein the quarter wave plate is disposed within the optical path so as maximize an optical efficiency of the optical path.

4. The optical path of claim 2, wherein the quarter wave plate is configured at an angle other than a nominal 45° angle relative to a polarization axis defined by the polarization beam splitter.

5. The optical path of claim 4, wherein the quarter wave plate is configured at the angle other than a nominal 45° angle that maximizes an optical efficiency of the optical path.

6. A method for improving an optical efficiency of an optical path, the optical path comprising a polarizing beam splitter, an optical component that introduces a phase retardance into the optical path, and a quarter wave plate, the method comprising:
adjusting a nominal orientation of the quarter wave plate relative to the polarizing beam splitter to improve an optical efficiency of the optical path.

7. The method of claim 6, wherein adjusting a nominal orientation of the quarter wave plate relative to the polarizing beam splitter comprises rotating the quarter wave plate relative to a polarization axis of the polarizing beam splitter off of a nominal 45° angle.

8. The method of claim 6, wherein adjusting a nominal orientation of the quarter wave plate relative to the polarizing beam splitter comprises tilting the quarter wave plate relative to an angle of incidence of the optical path off of a nominal 0° angle.

9. The method of claim 6, wherein adjusting a nominal orientation of the quarter wave plate relative to the polarizing beam splitter comprises tilting the quarter wave plate relative to an angle of incidence of the optical path off of a nominal 0° angle.

10. The method of claim 6, wherein adjusting a nominal orientation of the quarter wave plate relative to the polarizing beam splitter comprises:
detecting a reflected signal; and
adjusting a nominal orientation of the quarter wave plate relative to the polarizing beam splitter until a desired signal strength of the reflected signal is obtained.

11. The method of claim 6, wherein adjusting a nominal orientation of the quarter wave plate relative to the polarizing beam splitter comprises:
detecting a reflected signal; and
adjusting a nominal orientation of the quarter wave plate relative to the polarizing beam splitter until a signal strength of the reflected signal is maximized.

12. The method of claim 6, wherein adjusting a nominal orientation of the quarter wave plate relative to the polarizing beam splitter comprises:
adjusting the nominal orientation of the quarter wave plate based on the phase retardance introduced into the optical path by the optical component.
